(19) United States
(12) Patent Application Publication
(10) Pub. No.: US 2022/0337137 A1
(43) Pub. Date: Oct. 20, 2022

(54) TRANSLATION MOTOR AND A METHOD FOR PRODUCING A STATOR OF SUCH A TRANSLATION MOTOR

(71) Applicant: ISEL-AUTOMATION GMBH & CO. KG, Eiterfeld (DE)

(72) Inventor: Hugo Isert, Eiterfeld (DE)

(21) Appl. No.: 17/636,157

(22) PCT Filed: Aug. 10, 2020
(86) PCT No.: PCT/DE2020/000183

§ 371 Date: Feb. 17, 2022

(30) Foreign Application Priority Data
Aug. 23, 2019 (DE) 10 2019 005 951.4
Aug. 23, 2019 (DE) 20 2019 003 493.5

(51) Int. Cl. H02K 15/02; H02K 41/03; B21D 13/02; H02K 1/16

(52) U.S. Cl. CPC H02K 15/024; H02K 41/03; B21D 13/02; H02K 1/165; H02K 2201/18

(57) ABSTRACT

A translation motor includes a flat stator that defines a stator plane and has an upper face and a lower face. An active translation rotor is linearly displaceable relative to an X-axis along the stator plane. The upper face includes a toothed structure arranged linearly with respect to the X-axis and is defined by stator teeth and stator tooth spaces. The flat stator is defined by a stamping-shaped planar stator material and has a die side that is an elevated side and a punch side that is a recessed side. The die side has elevations that define the stator teeth. The die side defines the upper face and the punch side defines the lower face.

The invention relates to a translation motor and a method for producing a stator of such a translation motor.

Linear motors and planar motors are known as such from the prior art. Solutions with passive stators are known in particular. Further, such stators of linear and planar motors are known in which the toothed structure is obtained by milling out the gaps.

To achieve the most powerful and precise motor possible, the state of the art strives for a toothed structure with preferably small gaps and an exact geometry between the individual stator teeth. One disadvantage is that such production requires a high level of effort and material input, and the effort and precision required in manufacturing increases as the fineness of the tooth structure increases. This causes long manufacturing times and, in addition to high material input also high tool costs.

It is the task of the invention to provide a translation motor that can be produced at low cost and can be designed for a large spatial working range. Further, it is the task of the invention to provide an efficient method for producing a stator for this purpose, which is economic and low in wear and tear and allows low material input as well as low tool wear.

With regard to the translation motor, the task is solved by the features specified in claim 1. With regard to the production method, the task is solved by the features specified in claim 4. Preferred further embodiments result from the respective subclaims.

According to the invention, the translation motor has an active translation rotor and a flat stator.

A translation motor within the meaning of the present application is an electric motor in which a rotor moves relative to a stator in a plane in a translatory manner. Hence, the translation motor is used as a generic term for a linear motor with a drive movement in one translational degree of freedom and for a planar motor with a drive movement in two translational degrees of freedom.

According to the invention, the active translation rotor is movable relative to an X-axis in a stator plane.

The active translation rotor, hereinafter also abbreviated as translation rotor, is designed in a manner known per se. It has coils for generating a moving magnetic field and, by interacting with the stator, generates a driving force which causes the translation rotor to move.

The translation rotor is movable in a translatory manner relative to an X-axis. Here, the translation motor is a linear motor. The X-axis runs parallel to the stator plane. The translatory movement of the active translation rotor is guided along the X-axis preferably by means of at least one guiding element, hereinafter also referred to as a linear guide.

According to the invention, the flat stator has an upper face and a lower face.

The upper face and the lower face can have the same characteristics. Optionally, they can also differ, for example, in quality, coating or treatment. For example, it is possible that the upper face has different chemical properties than the lower face in order to support adhesion of a filling material for an optional filling of the tooth spaces of the toothed structure or, conversely, to counteract adhesion of dirt.

The upper face according to the invention has a toothed structure which is arranged linearly in the X-axis and is formed by stator teeth and stator tooth spaces.

This toothed structure is arranged along the X-axis of the planar stamped stator material. The geometrical form of the stator teeth can almost have any design here. However, it preferably corresponds to uniform simple shapes such as circles, ovals, squares or other polygons always provided in a regular, repeated sequence. The gaps between the individual stator teeth are called the tooth spaces, which are also preferably arranged in a regular repeated sequence. The stator teeth and the stator tooth spaces form magnetic pole pairs.

According to the invention, the flat stator is formed from a planar stator material reshaped by stamping and comprises a die side and a punch side. According to the invention, the die side is the raised side and the punch side is the recessed side of the stator material reshaped by stamping.

During stamp-reshaping, the die side is formed by the die and the punch side is formed by the punch. The die is also referred to as the upper punch and the punch as the lower punch.

The flat stator is made of a planar stator material which can be reshaped by stamping in a stamping process. The starting material used is a soft-magnetic material which, due to its ductility, can be stamped by cold forming. The starting material is provided as a sheet which is subject to stamping in pre-cut parts or as continuous roll material.

The stamped structures form the toothed structure with stator teeth and stator tooth spaces.

The method comprises a cold forming process realized by a stamping procedure. The stamping procedure can be carried out as a press stamping process or a roll stamping process.

The press stamping process is a non-continuous process in which pre-cut parts of the planar stator material are formed by pressing between the die and the punch.

During press stamping, the die has recesses which accommodate the planar stator material. The punch has elevations which press the planar stator material into the recesses of the die.

The roll stamping process can be carried out in a continuous or non-continuous manner. For a continuous process, the planar stator material is supplied as a continuous roll material to the process, reshaped by stamping in the process and rolled up again. Stamping is performed by means of a roll stamping machine comprising appropriately structured die and punch rollers. Similar to press stamping, the die roller has recesses into which the planar stator material is pressed by the elevations of the punch roller.

In the non-continuous process, the pre-cut parts of the planar stator material are guided through the stamping rollers and thus reshaped by stamping.

The upper face according to the invention is formed by the die side, which has elevations that in turn form the stator teeth.

The lower face according to the invention is formed by the punch side.

In press and roll stamping devices, the dies are usually arranged above and the punches below the planar stator material. Thus, after stamping, the die side forms the upper face, which has the raised stator teeth, and the punch side forms the lower face. Regardless of the spatial orientation, the upper face is always the side which faces the translation rotor.

Depending on the process, the toothed structure produced in a stamp-shaping process on the flat stator may be less precise than being produced in a subtractive shaping procedure, for example by milling. This can result in less precision in the movement of the translation rotor.

In return, the significant cost advantage is considerable in the production of extensive flat stators and compensates for these disadvantages in many applications in which the achievable precision is sufficient.

In detail, the cost advantage results from the production process which is characterized by almost no material loss and thus differs from the machining removal of the stator tooth spaces in manufacturing processes commonly used in the prior art up to now.

Particularly, in the production of large-surface stators, machining removal produces not only the material removed but also cause high wear of the cutting tools, which sometimes have to be maintained several times during a machining process. A particular advantage of the translation motor according to the invention is that there is no such wear of cutting tools. Instead, stamping tools can achieve considerably longer service lives.

Furthermore, in comparison to the machining process significant savings in time are achieved particularly in the production (particularly in the case of continuously guided roll stamping) of especially long or large-surface stators.

In contrast to the subtractive processes, the planar stator material is made more stable thanks to the stamping process, since the stamped structures and the stiffening of the material caused by cold forming lead to increased buckling stability.

A further advantage is that the shape of the toothed structure can be freely selected in a simple manner, whereas in the prior art only stator teeth with straight-line boundaries can be produced without considerable effort in a milling-out process.

Yet another advantage is the possibility, provided by the punch design, to additionally deform or structure the lower face in the same work step.

By shaping the lower face, a geometry obtained in this way makes it possible, as a particular advantage, to optimize the magnetic flux of the stator.

Further, by structuring the lower face, a larger surface can be generated, which, for example, results in greater strength of the glued joint when the stator is glued to a base.

In addition, it was surprisingly found that the structural change caused by the flow of the stator material during the stamp-reshaping process has an advantageous effect on the formation of the magnetic flux generated by the active rotor and passing through the pole pairs of the stator.

According to an advantageous development, the flat stator has a planar toothed structure in the X-axis and additionally in a Y-axis, which is formed by stator teeth and stator tooth spaces.

For this, the basic pattern created by the distribution of stator teeth and stator tooth spaces is symmetrical and repeatable in both the X-axis and the Y-axis.

According to this advantageous development, the active translation rotor is movable linearly relative to the X-axis and the Y-axis in the stator plane.

According to this development, the translation motor is designed as a planar motor. There are two linear degrees of freedom of the rotor movement so that the rotor can take any position in the plane above the stator.

According to a further advantageous development, the stamp-shaped planar stator material is formed by means of a pair of rollers in a roll stamping process.

The advantage of roll stamping is in particular the possibility of employing a continuous stamping process.

According to this advantageous development, the pair of rollers comprises a die roller, which forms the die side, and a punch roller, which forms the punch side.

The die roller is arranged above the upper face of the planar stator material and has recesses which accommodate the planar stator material by a material flow resulting from stamping.

The punch roller is assigned to the lower face of the planar stator material and has elevations which displace the planar stator material at this location and press it into the recesses of the die roller.

According to the invention, the method for producing a stator of a translation motor by means of a stamping tool comprises a die and a punch.

According to the invention, the method for producing a stator comprises the following process steps:
a) providing a planar ductile starting stator material,
b) creating a toothed structure by stamp-reshaping the starting stator material and obtaining the stamp-shaped planar stator material, wherein the toothed structure is created by means of the die at the upper face.

In the following, the process steps are described in more detail:
a) Providing a planar ductile starting stator material.

The planar stator starting material is preferably a metal sheet which is either cut into sections or wound on a supply roll. The metal is preferably an iron-containing alloy, for example steel, which has an appropriate ductility for the stamping process.

Providing is also to be understood as inserting into the stamping machine, which comprises the die and punch and is used for stamp-reshaping.

During insertion into the stamping machine, the planar stator starting material is positioned between the die and the punch. The upper face faces the die and the lower face faces the punch.
b) Creating the toothed structure by stamp-reshaping the stator starting material and obtaining the stamp-shaped planar stator material, wherein the toothed structure is created by means of the die on the upper face.

In this process step, the stamping machine reshapes the stator starting material by stamping and produces the stamp-shaped planar stator material.

In this process, the toothed structure is created by means of the recesses in the die on the upper face. At the same time, the pressing force acts as a counterforce on the lower face of the planar stator starting material. There, recesses are made by means of the punch. Reference is also made to the contents of the description of the flat stator of the translation motor, which apply here in the same way.

According to an advantageous development, the stator starting material is formed by press stamping in process step b).

Press stamping is a very cost-effective process which is particularly advantageous for the production of large numbers of pieces.

The stator starting material is inserted into a stamping tool consisting of a die and a punch. The die has recesses and the punch has elevations, which are guided towards each other when the tool is closed.

The punch presses, by means of its elevations, a part of the stator starting material into the recesses of the die, thus forming the stator teeth at this point. The recesses that are pressed in by the punch are located on the lower face.

According to a further advantageous development, the stator starting material is stamp-reshaped by roll stamping using a pair of rollers in process step b).

According to this advantageous development, the pair of rollers has a die roller and a punch roller, wherein the toothed structure is produced by the die roller. For this purpose, the die roller has recesses into which the planar stator starting material is pressed by the elevations of the punch roller. The shape and size of the stator teeth are determined by defining the geometry of the recesses. The non-concave structured surface portions of the die create the stator tooth spaces. Thus, the size of the stator tooth spaces can be adjusted by the circumferential spacing of the recesses in the die roller.

Roll stamping is particularly advantageous for a continuous machining process, in particular as an endless production from the roll.

According to a further development, process step b) is followed by process step c), wherein in process step c) the stator teeth of the planar stamp-shaped stator material are levelled by pressing on a top stator tooth surface.

After stamp-reshaping, the stator teeth may have process-related unevenness on their top surface, which could adversely affect the precision of the translation motor. The top surface of the stator teeth is understood to be the section of the surface contour of the stator teeth facing the translation rotor. Hereinafter, it is referred to as the top stator tooth surface. Preferably, the top stator tooth surface is, firstly, designed such that it is plane in itself. Secondly, the top stator tooth surfaces of all stator teeth are preferably on the same plane level.

By reworking the top surface of the stator teeth, they can be more precisely levelled and the precision of the translation motor can be further improved.

According to this development, such reworking of the stator teeth is advantageously carried out in a simple manner by a renewed pressing or rolling process using a flat pressing tool in order to level the surface of the stator teeth.

During this renewed pressing process, a smooth surface is pressed onto the stator tooth surface. In this way, shaping is performed by an unstructured flat die. This can be done by pressing or by rolling.

In the case of reworking by rolling, the stamp-shaped planar stator material is passed between two rollers, and at least the roller facing the stator tooth surface has a smooth, unstructured surface. The two rollers are spaced at a fixed distance, which is determined by the desired arrangement and shaping of the top stator tooth surface. Preferably, process steps b) and c) are then carried out in one work step. This means that the stamping rollers and the smoothing rollers are arranged one after the other and the stator starting material first passes through the stamping rollers and afterwards, as the stamped stator material thus obtained, through the smoothing rollers.

In a further development, levelling or additional levelling may be performed, alternatively or cumulatively, by face grinding or similar machining processes.

The invention is explained in more detail by way of example with reference to

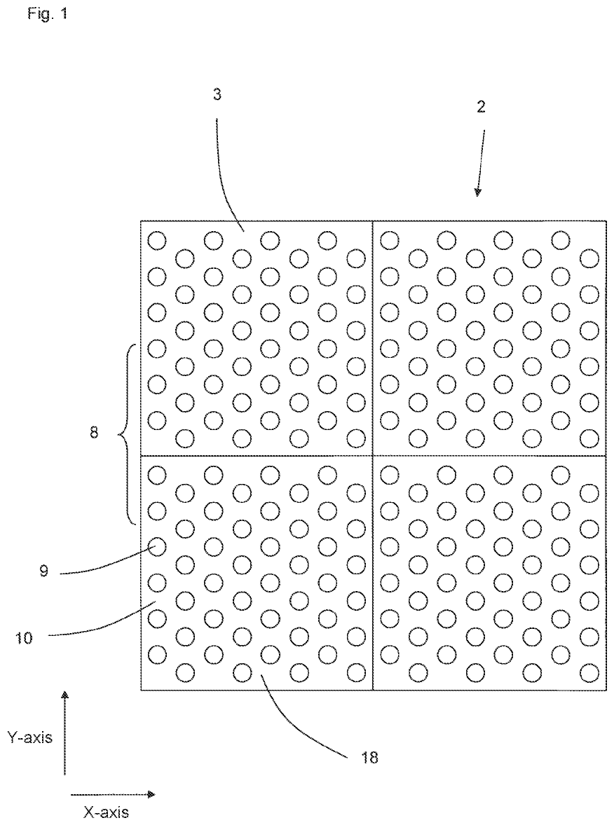

FIG. 1 flat stator (top view)

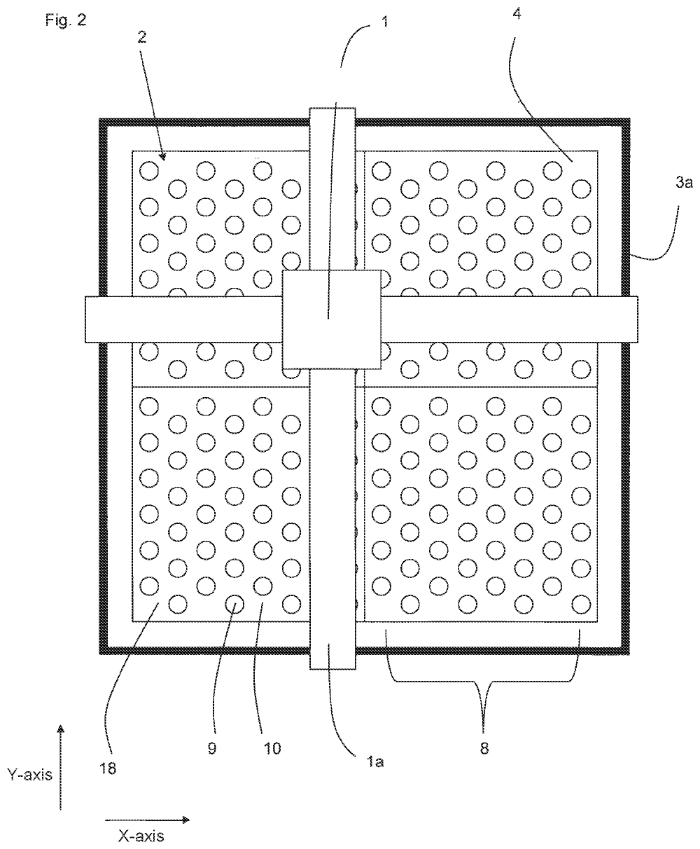

FIG. 2 translation motor (top view)

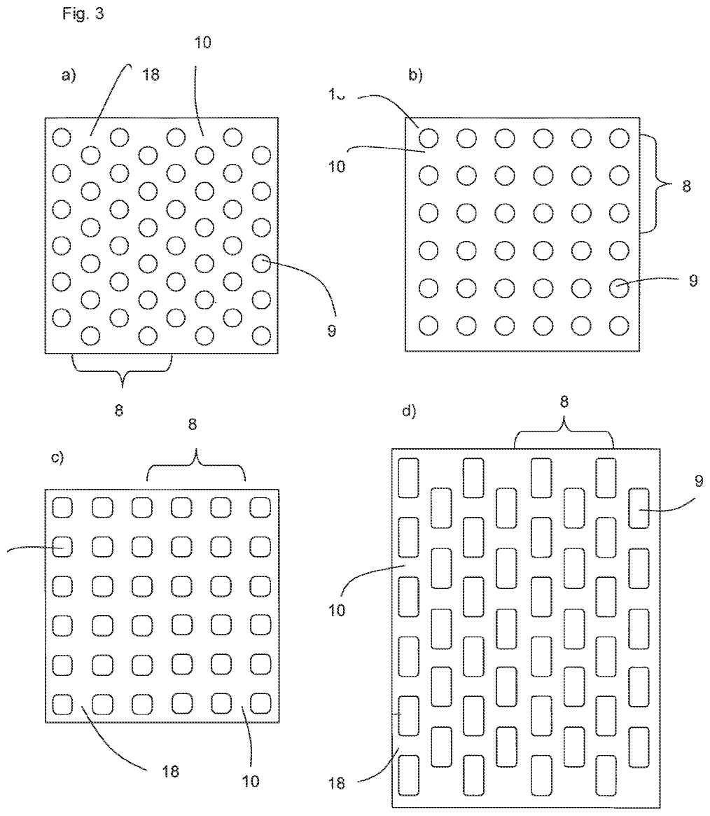

FIG. 3 stamp-shaped planar stator material in various designs

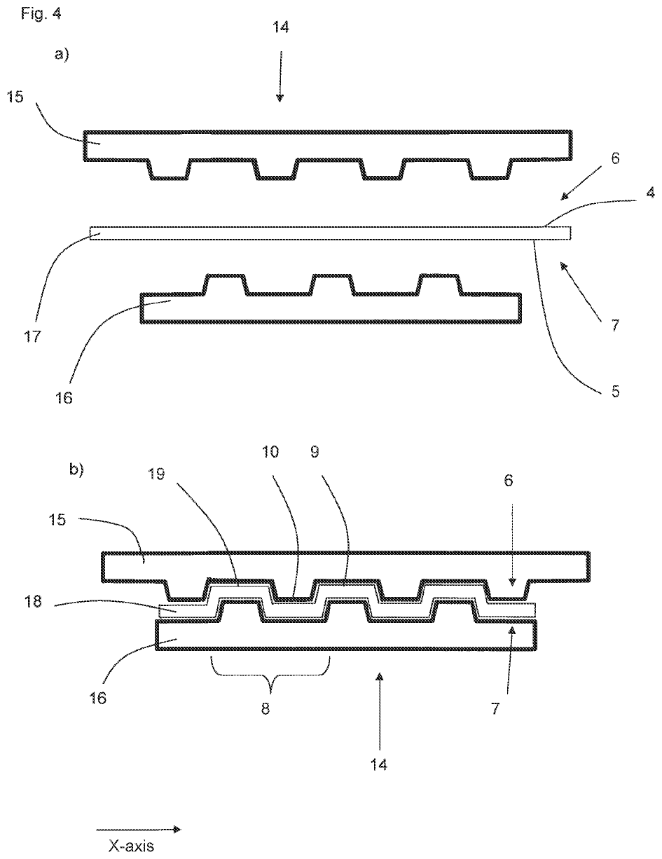

FIG. 4 production of the flat stator by means of a stamping tool

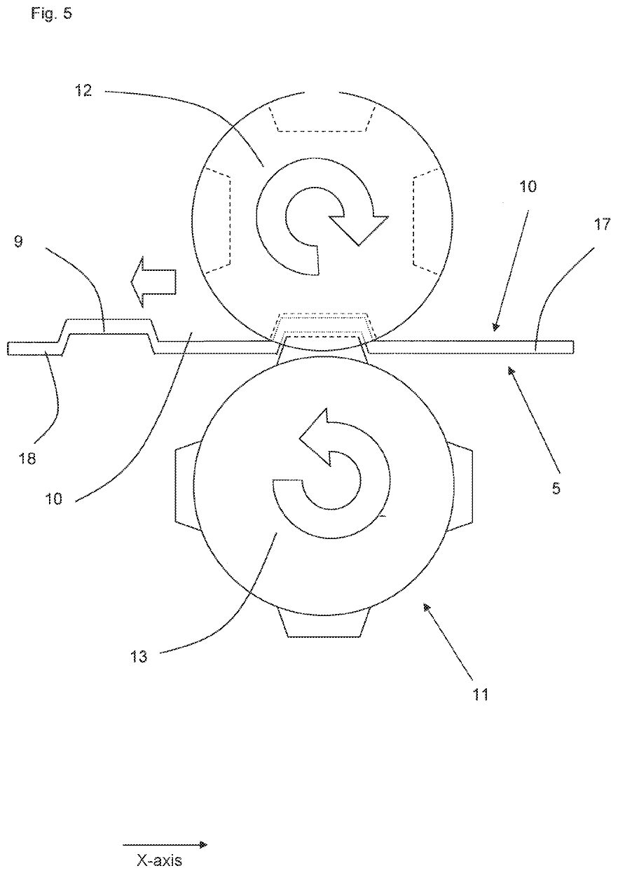

FIG. 5 production of the flat stator by means of a double roller

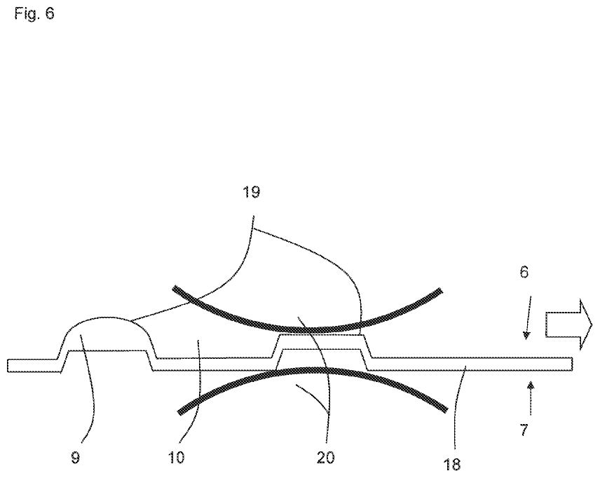

FIG. 6 reworking of the toothed structure.

FIG. 1 shows a top view of a finished flat stator 2. In this representation, the flat stator 2 is composed of four pieces of the stamp-shaped stator material 18, which are arranged next to each other in the stator plane 3.

The stamp-shaped stator material 18 has a toothed structure 8, which is formed by the stator teeth 9 and the stator tooth spaces 10.

In this embodiment, the toothed structure 8 has round stator teeth 9 arranged in staggered rows along the X-axis.

FIG. 2 shows a top view of the translation motor. Here, the translation motor is designed as a planar motor. In the planar motor, the translation rotor 1 can move in the X-axis and Y-axis over the stator plane 3, which is bounded by a simple frame structure 3a in this embodiment. The active translation rotor has two guiding elements 1a, which allow the active translation rotor 1 to move over the flat stator 2 without contacting it. The two guiding elements 1a are arranged at a right angle to each other and are movable along the frame structure 3a.

The flat stator 2 is designed in an analogous manner to the embodiment illustrated in FIG. 1.

FIG. 3 shows various embodiments of the stamp-shaped planar stator material 18. They differ in the shape and arrangement of the stator teeth 9. Thus, the arrangement of the round stator teeth 9 in staggered rows already described in conjunction with FIG. 1 is illustrated again in a). Further, the designs of round stator teeth 9 in non-staggered rows are illustrated in b), square stator teeth in non-staggered rows are illustrated in c), and rectangles in staggered rows are illustrated in d).

In all exemplary embodiments, the toothed structure 8 is formed by the stator teeth 9 and stator tooth spaces 10.

FIG. 4 is a side view of an example of the method for producing the flat stator 2 by means of a stamping tool 14. The stamping tool consists of a die 15 and a punch 16. The recesses of the die 15 and the elevations of the punch 16 engage with each other in the closed condition of the stamping tool 14.

In the first process step a), the planar stator starting material 17 is inserted into the opened stamping tool such that the upper face 4 faces the die 15 and the lower face 5 faces the punch 16. Thus, the upper face 4 is formed by the die side 6 and the lower face 5 is formed by the punch side 7. In this embodiment, the planar stator starting material 17 is provided discontinuously as a pre-cut part of a steel sheet.

In the second process step b), the stamping tool 14 is closed and the planar stator starting material 17 is pressed to form the stamp-shaped planar stator material 18.

The stator tooth 9 of the toothed structure 8 is stamped into the recesses of the die 15. The stator tooth space 10 is located in the non-recessed section of the die 15. And in this way, the toothed structure 8 is created.

The upper face 4 in the area of the stator teeth 9 forms the top stator tooth surface 19.

FIG. 5 shows a side view of the production of the flat stator 2 by means of a pair of rollers 11. The pair of rollers 11 is formed by the die roller 12 and the punch roller 13. The die roller 12 has recesses and the punch roller 13 has elevations. The pair of rollers 11 is arranged such that the recesses of the die roller 12 and the elevations of the punch roller 13 engage with each other, wherein the distance of the recesses corresponds to the desired stator tooth space size and is distributed along the roller circumference. The die roller 12 and the punch roller 13 rotate in opposite directions, thus further transporting the planar stator starting material 17.

In the first process step a), the planar stator starting material 17 is inserted into the rolling device.

If the pair of rollers 11 grips the planar stator starting material 17, this is drawn through the pair of rollers 11 in process step b) by the rotation of the rollers and is stamped at the same time. In this process, the stamp-shaped planar stator starting material is produced behind the rollers.

In this embodiment, the planar stator starting material 17 is supplied to the pair of rollers 11 as a continuous material, for example supplied from a roll.

FIG. 6 shows a reworking of the toothed structure 8. In order to increase the precision of the translation motor, the stator teeth 9 are reworked. Thus, in process step c), unevenness on the stator tooth surface 19 is eliminated by levelling using a smoothing tool 20. In this embodiment, the smoothing tool is formed by two rollers arranged at a fixed distance one to the other. The stamp-shaped planar stator material 18 is guided in the direction of the arrow to the right through the smoothing rollers, which smooth any unevenness, for example round bulges, and produce a planar top stator tooth surface 19.

### LIST OF REFERENCE NUMERALS

1 translation rotor
1a guiding elements
2 flat stator
3 stator plane
3a frame construction
4 upper face
5 lower face
6 die side
7 punch side
8 toothed structure
9 stator teeth
10 stator tooth spaces
11 pair of rollers
12 die roller
13 punch roller
14 stamping tool
15 die
16 punch
17 stator starting material
18 stamp-shaped planar stator material
19 top stator tooth surface
20 smoothing tool

1-7. (canceled)

8. A translation motor, comprising:
a flat stator defining a stator plane and having an upper face and a lower face;
an active translation rotor being linearly displaceable relative to an X-axis along the stator plane;
said upper face including a toothed structure arranged linearly with respect to the X-axis and defined by stator teeth and stator tooth spaces;
said flat stator being defined by a stamping-shaped planar stator material, having a die side being an elevated side and a punch side being a recessed side, said die side having elevations defining said stator teeth, said die side defining said upper face and said punch side defining said lower face.

9. The translation motor according to claim 8, wherein said toothed structure is arranged in a planar manner relative to the X-axis and to a Y-axis, and wherein the active translation rotor is moveable linearly to the Y-axis in the stator plane.

10. The translation motor according to claim 8 wherein the stamping-shaped planar stator material has the characteristics of being formed by roller stamping by a pair of rollers defined by a die roller that defines the die side and a punch roller that defines the punch side.

11. A method for producing a stator of a translation motor comprising:
providing a stamping tool having a die and a punch,
carrying out the following process steps:
a) providing a planar ductile stator starting material;
b) stamp-reshaping the stator starting material and obtaining stamp-shaped planar stator material having a toothed structure including stator teeth defined by elevations generated by the die on an upper face of the stator material.

12. The method of producing a stator of a translation motor according to claim 11, wherein the stamp-reshaping of the stator starting material is carried out by press stamping.

13. The method of producing a stator of a translation motor according to claim 11, wherein the stamp-reshaping of the stator starting material is carried out by roll stamping using a pair of rollers, the pair of rollers includes a die roller and a punch roller, the toothed structure is defined by the die roller.

14. The method of producing a stator of a translation motor according to claim 11, further comprising subsequent to the process step b), pressing on a top stator tooth surface for smoothing stator teeth of the toothed structure.
